(19) United States
(12) Patent Application Publication
(10) Pub. No.: US 2014/0304118 A1
(43) Pub. Date: Oct. 9, 2014

(54) PRODUCT COMPARISON APPARATUS AND METHOD

(71) Applicant: KABUSHIKI KAISHA TOSHIBA, Tokyo (JP)

(72) Inventors: Kenta Cho, Kawasaki-shi (JP); Masayuki Okamoto, Kawasaki-shi (JP); Kosei Fume, Kawasaki-shi (JP); Masaru Suzuki, Kawasaki-shi (JP)

(73) Assignee: KABUSHIKI KAISHA TOSHIBA, Tokyo (JP)

(21) Appl. No.: 14/195,741

(22) Filed: Mar. 3, 2014

(30) Foreign Application Priority Data
Mar. 21, 2013 (JP) 2013-058911

(51) Int. Cl. G06Q 30/06

(52) U.S. Cl. CPC G06Q 30/0629
USPC 705/26.64

(57) ABSTRACT

According to an embodiment, a product comparison apparatus for comparing a plurality of products includes an operation acceptance unit, a comparison table generator, and a display unit. The operation acceptance unit is configured to accept a user operation for selecting a plurality of annotated documents which include specification information items related to the products and annotations appended by a user. The comparison table generator is configured to generate a comparison table comprising the specification information items related to the products, in accordance with the user operation. The display unit is configured to display the comparison table.

### CROSS-REFERENCE TO RELATED APPLICATIONS

This application is based upon and claims the benefit of priority from Japanese Patent Application No. 2013-058911, filed Mar. 21, 2013, the entire contents of which are incorporated herein by reference.

### FIELD

Embodiments described herein relate generally to a product comparison apparatus and method.

### BACKGROUND

A product comparison apparatus is known which searches for products according to a search condition designated by the user and displays a list of information items related to products obtained as a result of the search. In such product comparison apparatus, it is often troublesome to designate or change the search condition.

A product comparison apparatus is required to allow the user to compare products by a simple operation.

### BRIEF DESCRIPTION OF THE DRAWINGS

FIG. 1 is a schematic block diagram showing a product comparison apparatus according to one embodiment;

FIG. 2 is a schematic flowchart showing an operation example of the product comparison apparatus shown in FIG. 1;

FIG. 3 is a view showing an example of an annotate UI displayed by an annotation unit shown in FIG. 1;

FIG. 4 is a view showing a state in which a document displayed on the annotate UI shown in FIG. 3 is annotated;

FIG. 5 is a table showing an example of data of an annotated document stored in an annotated document DB shown in FIG. 1;

FIG. 6 is a view showing a scrap document generation screen including an annotated document list UI displayed by an annotated document list display unit shown in FIG. 1 and a scrap document generation UI displayed by a scrap document generator shown in FIG. 1;

FIG. 7 is a view showing the scrap document generation screen after annotated documents displayed on the annotated document list UI shown in FIG. 6 are pasted on the scrap document generation UI;

FIG. 8 is a view showing the scrap document generation screen after the annotated document list UI shown in FIG. 7 is hidden;

FIG. 9 is a view showing the scrap document generation screen after comparison table generation strokes are written on the scrap document generation UI shown in FIG. 8;

FIG. 10 is a view showing an example of a comparison table generated by a comparison table generator shown in FIG. 1;

FIG. 11 is a table showing an example of related document acquisition conditions set by the comparison table generator shown in FIG. 1;

FIG. 12 is a view showing an annotation example on a scrap document;

FIG. 13 is a table showing an example of related document acquisition conditions set by the comparison table generator shown in FIG. 1 after the scrap document is annotated; and

FIG. 14 is a view showing an example in which related documents acquired by a related document acquisition unit shown in FIG. 1 are added to the comparison table.

### DETAILED DESCRIPTION

According to an embodiment, a product comparison apparatus for comparing a plurality of products includes an operation acceptance unit, a comparison table generator, and a display unit. The operation acceptance unit is configured to accept a user operation for selecting a plurality of annotated documents which include specification information items related to the products and annotations appended by a user. The comparison table generator is configured to generate a comparison table comprising the specification information items related to the products, in accordance with the user operation. The display unit is configured to display the comparison table.

Various embodiments will be described hereinafter with reference to the accompanying drawings.

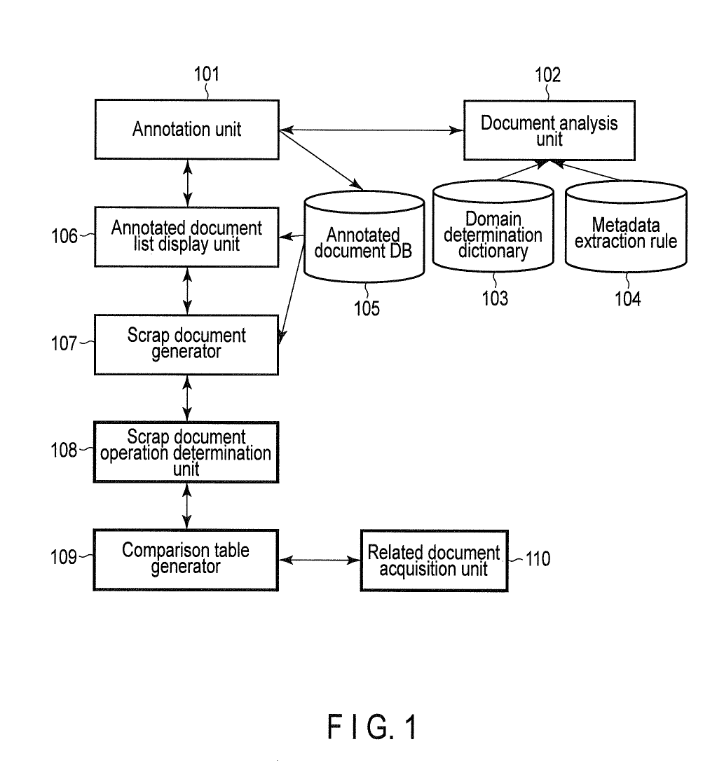

FIG. 1 schematically shows a product comparison apparatus according to an embodiment. As shown in FIG. 1, this product comparison apparatus includes an annotation unit 101, document analysis unit 102, domain determination dictionary 103, metadata extraction rule 104, annotated document database (DB) 105, annotated document list display unit 106, scrap document generator 107, scrap document operation determination unit 108, comparison table generator 109, and related document acquisition unit 110. The product comparison apparatus according to this embodiment is applicable to, for example, terminal apparatuses such as a personal computer (PC), tablet type terminal, and smartphone.

The annotation unit 101 accepts a user operation for annotating on a document such as a Web page. More specifically, the annotation unit 101 provides an annotate user interface (UI) which displays a document and allows the user to annotate the document using an input device. The document is, for example, a Web page, e-book, electronic document obtained by reading a paper document (for example, a magazine) using an optical reading device such as a camera or scanner and converting the read data into a digital document, and includes a specification information item of a product such as a hotel, restaurant, tourist spot, home electronics, book, or game. Annotating a document means appending information (annotation) to a document (for example, placing a mark on a document, writing characters (for example, a comment) on a document, and so forth). The input device allows handwriting input with a pen or finger. For example, the input device includes a touch panel arranged on a display screen of a display device, and a pen for operating the touch panel.

In this embodiment, the user inputs a desired annotation at a desired position on a document displayed on the annotate UI by using the pen. The document to which an annotation is appended (to be referred to as an annotated document hereinafter) is stored in the annotated document DB 105. The annotated document DB (to be also referred to as a storage unit) 105 stores a plurality of annotated documents corresponding to a plurality of products, respectively. Note that the annotated document DB 105 need not always be arranged in the product comparison apparatus, and may be arranged in another apparatus (for example, a server) which communicates with the product comparison apparatus.

The document analysis unit 102 analyzes an annotated document. More specifically, the document analysis unit 102 executes domain determination for an annotated document using the domain determination dictionary 103, and executes metadata extraction for an annotated document using the metadata extraction rule 104. A domain indicates, for example, a product category such as a hotel, restaurant, tourist spot, home electronics, book, or game, and the domain determination indicates processing for determining a product category related to information of a document to be analyzed. Metadata indicates information related to specifications (attributes) of a product of each domain. For example, when the domain is a hotel, metadata indicates specification information of that hotel, which includes a place, location, meal, price, and the like.

The annotated document list display unit 106 provides an annotated document list UI which presents a list of annotated documents stored in the annotated document DB 105. The scrap document generator 107 provides a scrap document generation UI used to generate a scrap document. The scrap document generation UI displays a scrap document screen, and accepts a user operation for the scrap document screen. The scrap document generation UI allows the user to paste an annotated document displayed on the annotated document list UI on the scrap document screen, and to annotate the scrap document screen using a pen. The annotated document list UI and scrap document generation UI can be displayed side by side on a single screen.

In this embodiment, by pasting a plurality of annotated documents of an identical domain of those displayed on the annotated document list UI onto the scrap document screen, the user can compare products (to be also referred to as a product group of an identical domain) corresponding to the annotated documents. The annotated document list UI and scrap document generation UI function as an operation acceptance unit which accepts user operations for selecting a plurality of annotated documents corresponding to a plurality of products, so as to allow the user to compare these products.

The scrap document operation determination unit 108 determines whether or not a user operation on the scrap document screen includes a user's intention (for example, the user wants to compare products, the user wants to attach importance to a specific specification upon product comparison, and so forth). The comparison table generator 109 generates a comparison table used to compare a plurality of products corresponding to a plurality of annotated documents selected by the scrap document generator 107. The comparison table describes specification information items of respective products. The comparison table is displayed on the scrap document generation UI. That is, the scrap document generation UI of the scrap document generator 107 also functions as a display unit which displays the comparison table.

The related document acquisition unit 110 searches the annotated document DB 105 according to a search condition, and acquires related documents which meet the search condition. More specifically, the related document acquisition unit 110 acquires annotated documents (to be also referred to as related documents) related to products, which are related to those products corresponding to annotated documents pasted on the scrap document screen. The search condition will be described later.

In this embodiment, a document (to be also referred to as product information) related to a product that the user becomes interested in is stored together with specification information corresponding to that product. For this reason, by an operation for selecting annotated documents related to products to be compared using the pen, the comparison table can be generated. Furthermore, when the user inputs contents to which the user wants to attach importance on the comparison table using the pen, specification information items related to products which meet a condition desired by the user can be added to the comparison table. In this manner, product comparison can be made by a simple operation.

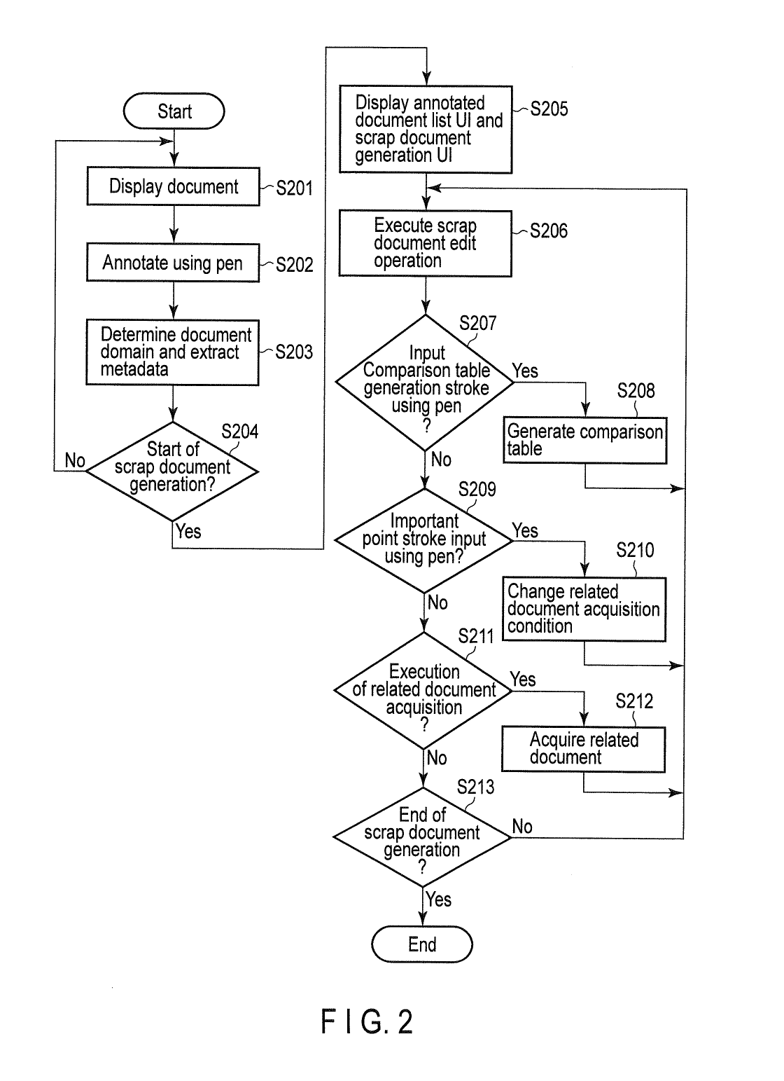

FIG. 2 schematically shows an operation example of the product comparison apparatus according to this embodiment. In FIG. 2, the annotation unit 101 displays a document in step S201. The annotate UI allows the user to make the same operations (to scroll, to follow a link, and so forth) as a standard Web browser by operations using a pen or finger. Also, the user can directly designate a URL (Uniform Resource Locator) using a software keyword or the like, can conduct a Web page search using a search engine, and so forth via the annotate UI.

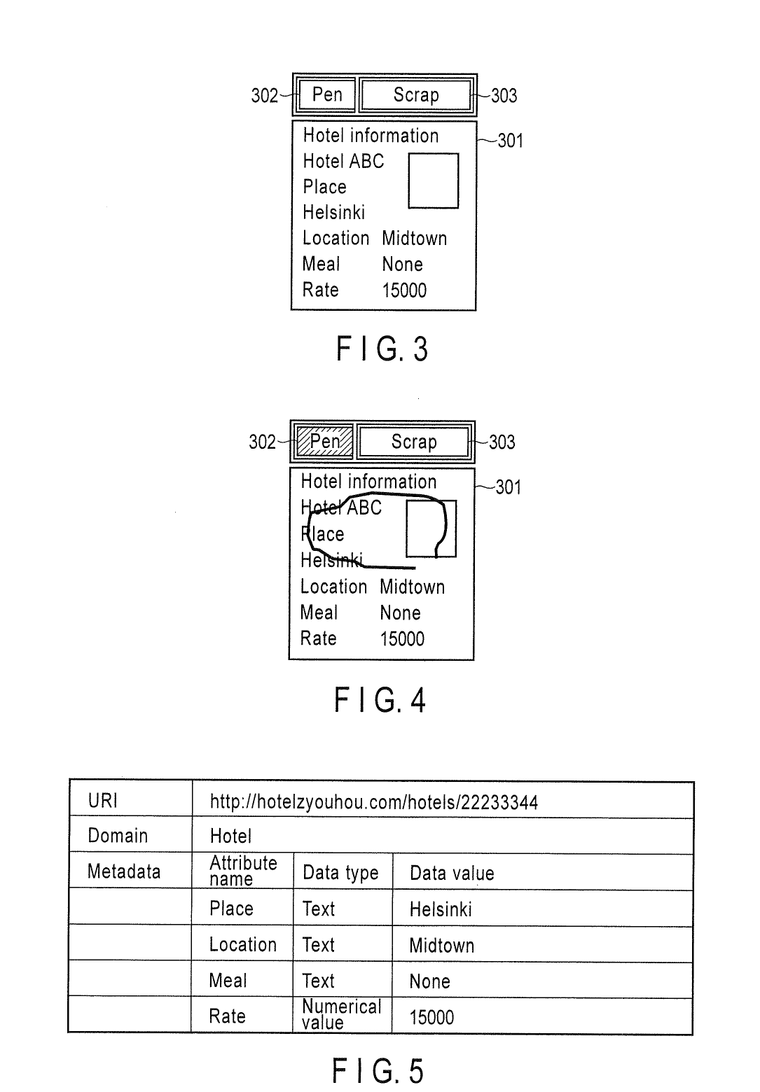

FIG. 3 shows an example of an annotate UI 301 of the annotation unit 101. In FIG. 3, a pen button 302 and scrap button 303 are laid on the annotate UI 301. The annotate UI 301 displays a Web page which describes a specification information item related to Hotel ABC in a hotel information site which describes specification information items of hotels. As the specification information item of Hotel ABC, [place]=“Helsinki”, [location]=“midtown”, [meal]=“none”, and [rate]=“15000” yen are displayed. Furthermore, an image of Hotel ABC is displayed.

In step S202 of FIG. 2, the user annotates the document displayed on the annotate UI using the pen. For example, assume that the user gets interested in Hotel ABC during browsing of the Web page of Hotel ABC, as shown in FIG. 3. In this case, in order to change the annotate UI 301 from a browse mode to an annotate mode, the user presses the pen button 302 using the pen or finger. After the pen button 302 is pressed, the display state of the pen button 302 changes, as shown in FIG. 4, and the annotate UI 301 transits to the annotate mode. In the annotate mode, the user can annotate the document displayed on the annotate UI 301 using the pen. The example of FIG. 4 shows a screen on which Hotel ABC is circled.

Note that the annotate UI of the annotation unit 101 is not limited to such specific example in which the UI transits to the annotate mode by pressing the pen button 302. For example, in a terminal apparatus which can distinguish a pen operation and an operation with a finger, the annotation unit 101 may judge the operation with the finger as that which is not in the annotate mode. In this case, the user can annotate the document by the pen operation but cannot annotate the document by the operation with the finger.

When the document is annotated, the document and information of an annotation given to this document are automatically recorded in the annotated document DB 105. In step S203 of FIG. 2, the document analysis unit 102 analyzes the recorded document to determine a domain of the document and to extract metadata from the document. For example, the domain of the document is determined by collating the distribution of keywords included in the document and the domain determination dictionary 103 which is prepared in advance and includes keywords which frequently appear in respective domains. When the document is a Web page, the domain of the document may be determined using a correspondence table between URLs and domains. The metadata is extracted from the document using the metadata extraction rule 104, which includes a rule for specifying and extracting a description part of metadata using a word dictionary which means that metadata, and a rule for, when the document is a Web page, holding the structure of a site as data in advance, and specifying and extracting a structure where target metadata is located using that data.

FIG. 5 shows data of an annotated document stored in the annotated document DB 105. More specifically, FIG. 5 shows data of the annotated document stored in the annotated document DB 105 when the user annotates Hotel ABC shown in FIG. 4. Data shown in FIG. 5 includes a URI (Uniform Resource Identifier) corresponding to the ID (Identification Data) of the document, the determined domain, and the extracted metadata. Furthermore, the annotated document DB 105 stores information of an annotation written by the user using the pen together with the data shown in FIG. 5. The metadata includes the attribute names of respective attributes corresponding to the domain of the annotated document, data types used upon description of the respective attributes, and data values indicating contents corresponding to the respective attributes. For a data type, for example, one of text and a numerical value is assigned. Note that the data type is not limited to this example, and a position, a numerical value of a specific unit, and the like may be assigned.

In step S204 of FIG. 2, it is checked whether or not to start generation of a scrap document. In the above example, the scrap button 303 (FIG. 3) used to start generation of a scrap document is arranged. In this case, it is checked in step S204 whether or not the user presses the scrap button 303. If the user presses the scrap button 303, the annotated document list UI and scrap document generation UI are displayed (step S205).

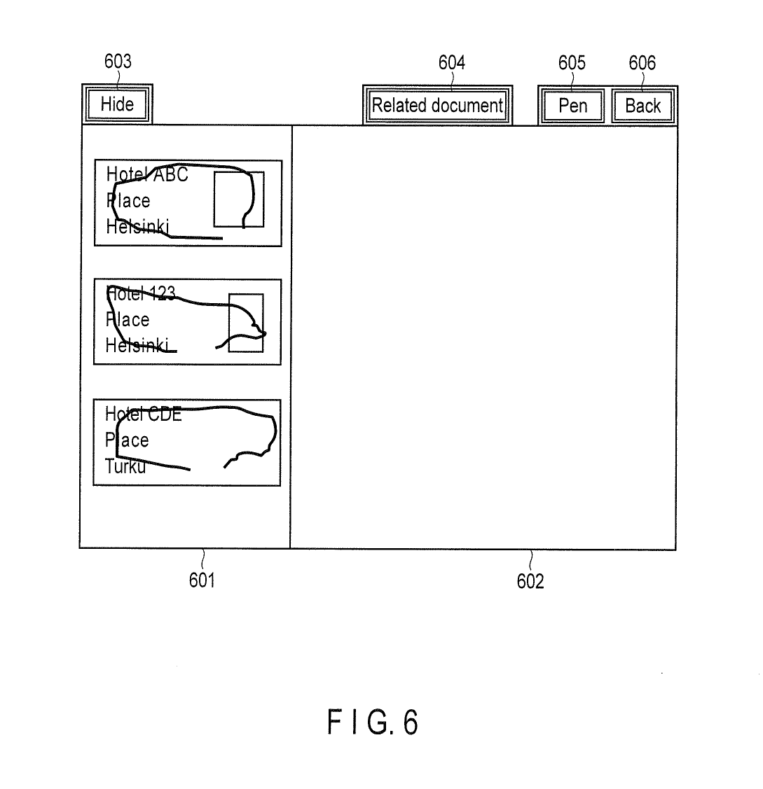

FIG. 6 shows an example of the scrap document generation screen. On the scrap document generation screen shown in FIG. 6, an annotated document list UI 601 and scrap document generation UI 602 are laid out side by side, and the annotated document list UI 601 is located at a left neighboring position of the scrap document generation UI 602. Above the annotated document list UI 601, a hide button 603 used to hide the annotated document list UI 601 is laid out. Above the scrap document generation UI 602, a related document button 604 used to conduct a related document search, a pen button 605 used to change to the annotate mode that allows the user to annotate the scrap document screen using the pen, and a back button 606 used to end generation of a scrap document are laid out.

The annotated document list UI 601 displays Web pages of hotels annotated by the user most recently. In the example in FIG. 6, Web pages related to Hotel ABC, Hotel 123, and Hotel CDE are displayed. In this example, the annotated document list UI 601 displays a clipped part (around a portion annotated by the user using the pen) of the document.

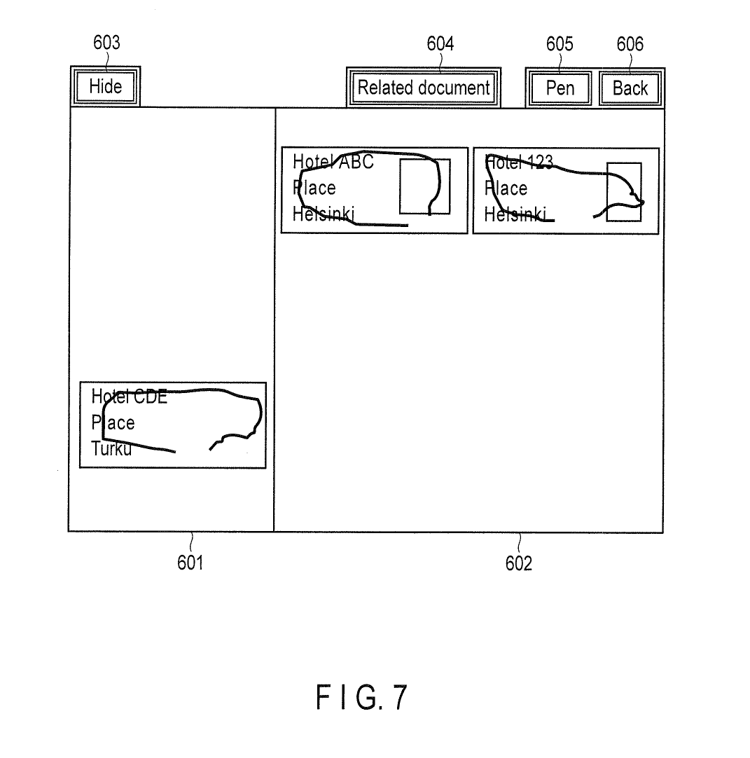

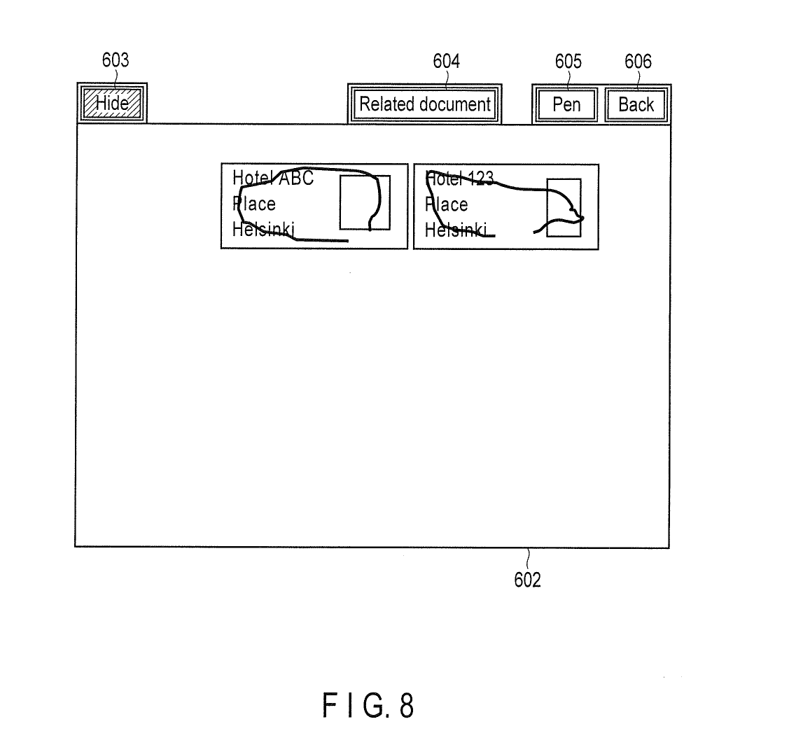

In step S206 of FIG. 2, the user generates, that is, edits a scrap document. The user drags each annotated documents displayed on the annotated document list UI 601 onto the scrap document generation UI 602 using the pen, thus pasting a desired annotated document on the scrap document screen. FIG. 7 shows a screen after the annotated document corresponding to Hotel ABC and that corresponding to Hotel 123 are pasted on the scrap document screen. The annotated document list UI 601 can be hidden from the screen by pressing the hide button 603. FIG. 8 shows a screen after the annotated document list UI is hidden.

On the scrap document generation UI 602, the user can annotate the scrap document screen using the pen in the same manner as the annotate UI. In order to annotate the scrap document screen, the user presses the pen button 605 to make the scrap document generation UI 602 transit to the annotate mode. When the user performs an operation on the scrap document screen, for example, when the user annotates the scrap document screen using the pen, or changes the pasted position of an annotated document by dragging, the scrap document operation determination unit 108 estimates the objective of that operation.

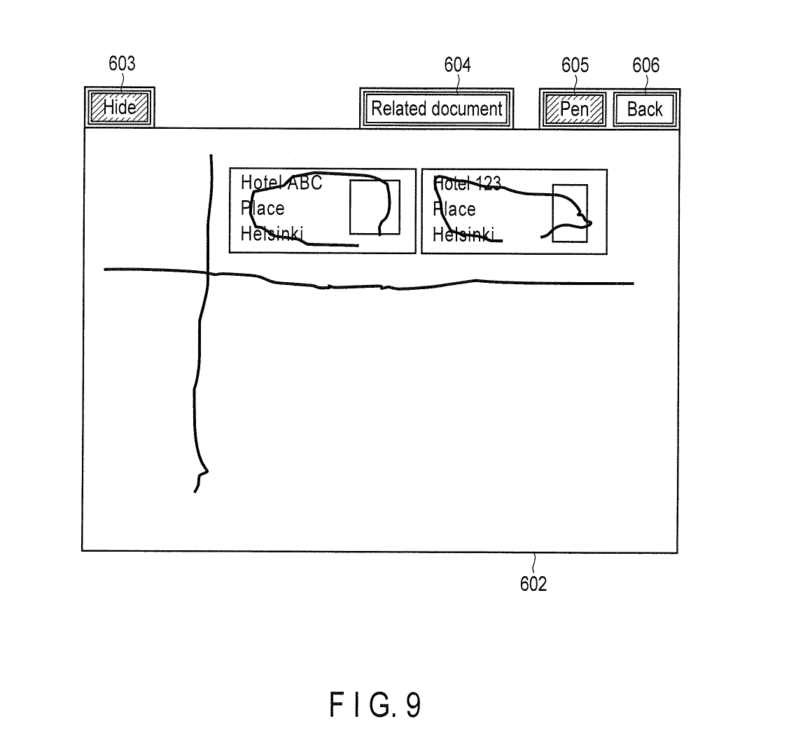

In step S207 of FIG. 2, the scrap document operation determination unit 108 determines whether or not the user inputs comparison table generation strokes using the pen. When products related to annotated documents pasted on the scrap document screen are to be compared, the user writes lines (strokes) corresponding to the comparison table. FIG. 9 shows an input example of comparison table generation strokes using the pen. In FIG. 9, cross lines are written so as to locate annotated documents on an upper right portion thereof. In this example, when the scrap document operation determination unit 108 detects a plurality of annotated documents of the identical domain on the upper right portion of the cross lines, the scrap document operation determination unit 108 determines that comparison table generation strokes are input. If the comparison table generation strokes are input, the process advances to step S208.

In the example of FIG. 9, two products (that is, Hotel ABC and Hotel 123) are selected as comparison targets. However, the number of products to be selected may be one or three or more. The comparison table generation start method is not limited to the example in which the user inputs predetermined strokes using the pen, and a button used to start comparison table generation may be arranged. Alternatively, a comparison table may be automatically generated when an annotated document is pasted on the scrap document screen.

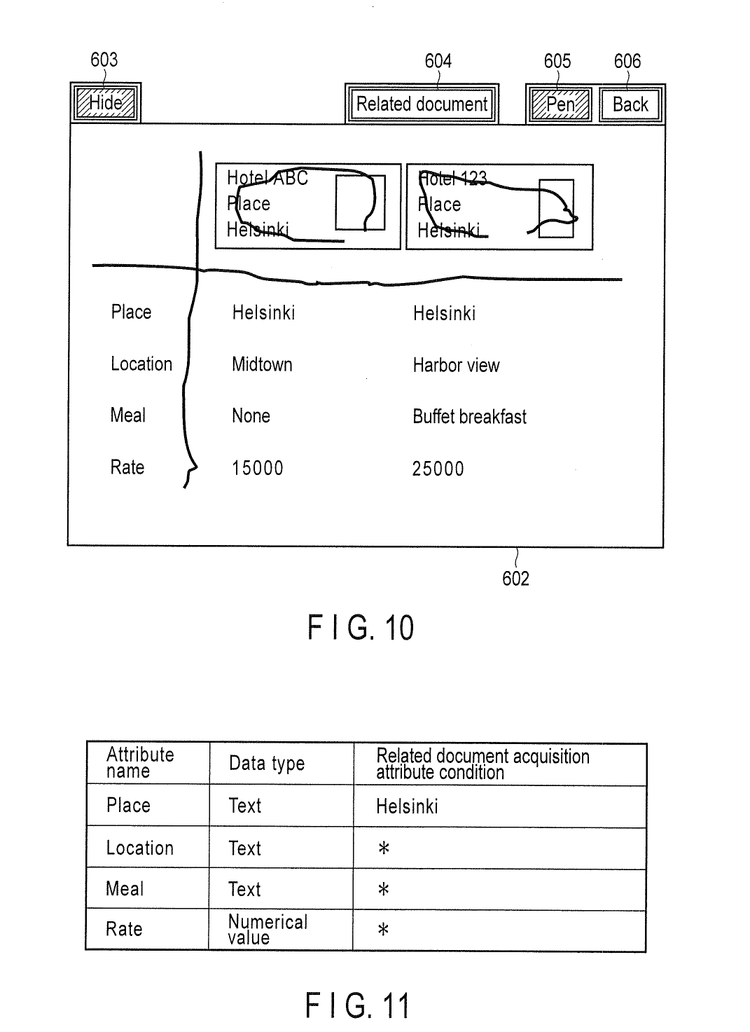

In step S208, the comparison table generator 109 generates a comparison table using metadata included in annotated documents corresponding to products to be compared. FIG. 10 shows an example of the comparison table generated by the comparison table generator 109. Attribute names included in the metadata are displayed on a lower left portion of the comparison table, and data values corresponding to the annotated documents displayed above are displayed on a lower right portion of the comparison table. When the comparison table generator 109 generates the comparison table, related document acquisition conditions (also called search conditions) are set in the related document acquisition unit 110. The related document acquisition conditions include information indicating viewpoints used when the user searches for products, and related documents desired by the user. FIG. 11 shows an example of data of the related document acquisition conditions. In FIG. 11, the related document acquisition conditions indicate attribute values as to whether products to be presented as related documents need to have exact attribute values or may have close attribute values. In the related document acquisition condition data shown in FIG. 11, a related document acquisition condition associated with [place] is set as “Helsinki”. The related document acquisition unit 110 searches for annotated documents corresponding to products including “Helsinki” as [place] according to the related document acquisition condition data shown in FIG. 11. “*” set in related document acquisition conditions associated with [location], [meal], and [price] means that arbitrary annotated documents can be searched for in association with these attributes.

The related document acquisition conditions are generated in such a manner that the metadata of the products described in the comparison tables are compared, and when there are a plurality of products including identical or closer metadata, these contents are added as conditions. In the comparison table shown in FIG. 10, since both Hotel ABC and Hotel 123 include [place]=“Helsinki”, the related document acquisition condition associated with [place] is set as “Helsinki”. That is, the related document acquisition condition used to search for hotels, the place of which is “Helsinki”, is generated.

The related document acquisition conditions may be generated based on the user's preferences. More specifically, the related document acquisition conditions may be set from metadata of documents ordinarily annotated by the user. For example, in hotels annotated by the user so far, when the ratio of hotels including [meal]=“buffet breakfast” exceeds a predetermined level, a condition “buffet breakfast” may be set in association with [meal] irrespective of the contents of annotated documents pasted on the scrap document screen.

Data types other than text and a numerical value may be set. For example, a data type “position” may be prepared in association with [place]. In this case, the related document acquisition unit 110 can search for documents which describe hotels within a predetermined range from the latitude and longitude of Helsinki.

After the comparison table is generated in step S208 of FIG. 2, it is displayed on the scrap document generation UI 602, as shown in FIG. 9, and the process returns to step S206. In step S206, the user can edit the comparison table displayed on the scrap document generation UI 602. When the comparison table has already been generated, the determination processing of step S207 can be omitted.

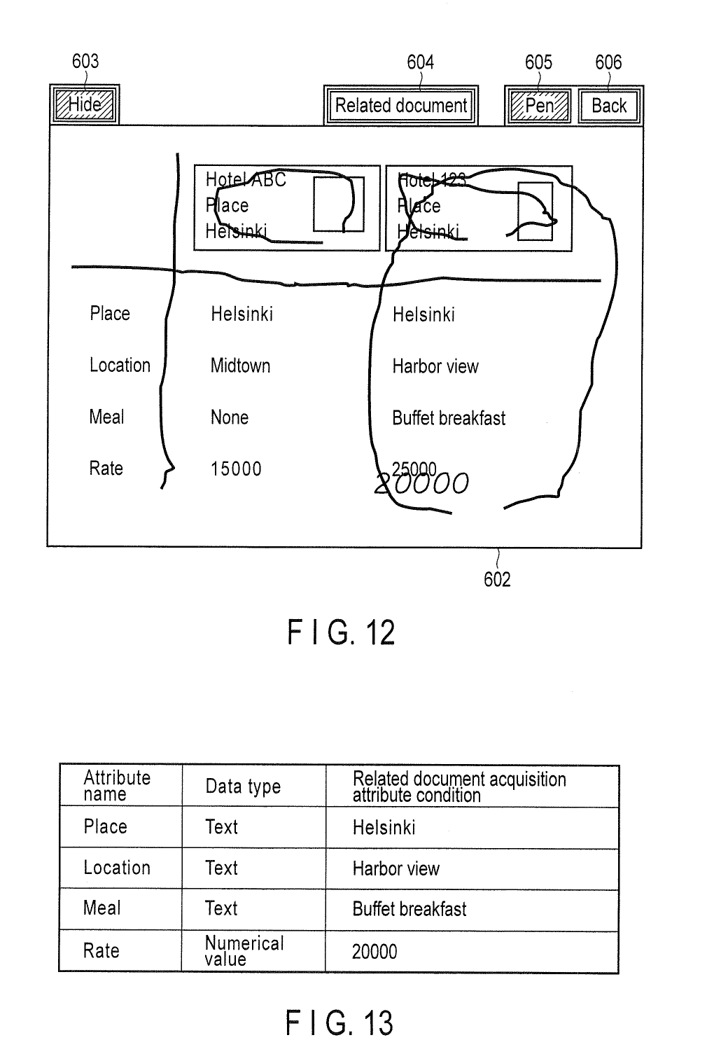

The scrap document operation determination unit 108 determines in step S209 whether or not the user inputs an important point stroke. For example, the user annotates an important point of a related document on the scrap document screen (or on the comparison table in the scrap document screen) (for example, the user circles a specific product or a specific data value). When the scrap document operation determination unit 108 detects such user operation, it determines that the important point stroke is input. If the important point stroke is input, the process advances to step S210. In step S210, the scrap document operation determination unit 108 rewrites the related document acquisition condition data in the related document acquisition unit 110 according to the contents of the user operation. FIG. 12 shows an example in which the user annotates the comparison table. More specifically, FIG. 12 shows a state in which the user entirely surrounds Hotel 123 with a line, and also overwrites “20000” on “25000” as [rate]. In response to this operation, the scrap document operation determination unit 108 attaches importance to the data value circled by the user (the data value concerning Hotel 123), and determines that the user intends to change the overwritten contents to that data value, thus changing the related document acquisition conditions.

As a change of a related document acquisition condition by annotating, by placing a strikethrough or a cross (x) on a specific data value, a condition used to acquire a related document other than the specific data value may be set. As for an attribute, a data type of which is a numerical value, a numerical value range may be designated by adding an inequality sign. For example, the user may write “18000 to 22000” in the column of [price] in the comparison table. When the user has already circled a specific data value of an annotated document at an annotating timing (that is, at the processing timing of step S202 in FIG. 2 before that annotated document is recorded in the annotated document DB 105), the comparison table generator 109 may determine that the user attaches importance to that specification (attribute) in the same manner as a circle put on the scrap document screen, and may generate the related document acquisition condition. In this manner, by adding an annotation indicating an importance point to a document at the annotating timing, the user's preference can be reflected on the related document acquisition condition.

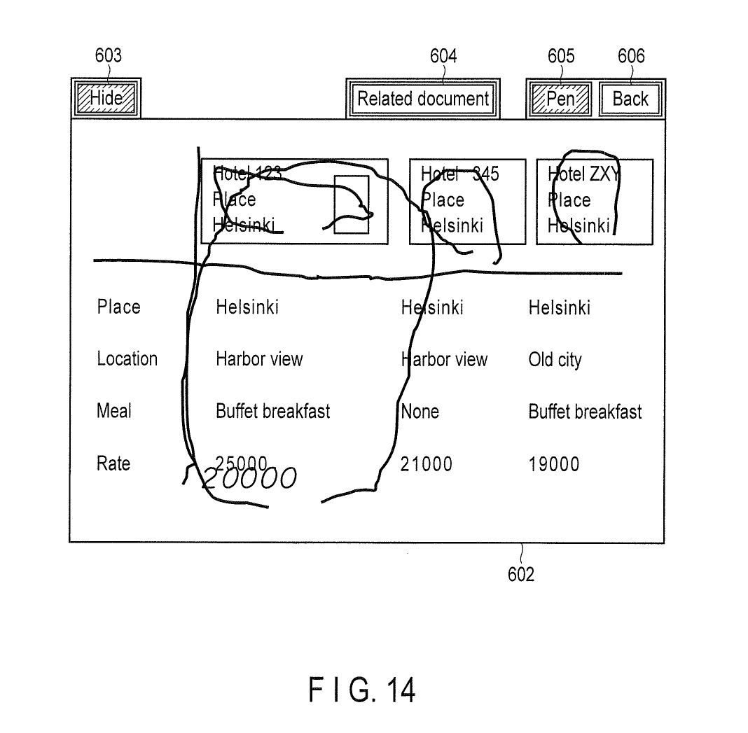

FIG. 13 shows an example of related document acquisition condition data when the comparison table is annotated, as shown in FIG. 12. In the related document acquisition conditions shown in FIG. 13, “harbor view” for [location] and “buffet breakfast” for [meal] are set as related document acquisition conditions, and a numerical value “20000” obtained as a result of handwriting recognition is set for rewritten [rate].

In the related document acquisition condition, a plurality of data values may be set for each attribute. For example, two conditions “midtown” and “harbor view” may be set for [location]. In this case, an OR search of “midtown” and “harbor view” is conducted upon searching for related documents.

The related document acquisition unit 110 determines in step S211 whether or not the user makes an operation required to acquire a related document. For example, when the related document acquisition unit 110 detects that the user presses the related document button 604, it determines that the user makes the operation required to acquire a related document. In this case, the process advances to step S212. In step S212, the related document acquisition unit 110 searches the annotated document DB 105 according to the related document acquisition conditions, and acquires a related document which meets the related document acquisition conditions. This related document and its specification information are additionally displayed on the comparison table. FIG. 14 shows an example of a screen in which related documents acquired according to the related document acquisition conditions shown in FIG. 13 are displayed on the comparison table. In the related document acquisition conditions shown in FIG. 13, [place]=“Helsinki”, [location]=“harbor view”, [meal]=“buffet breakfast”, and [rate]=“20000” are set. In this case, an annotated document having metadata that match these related document acquisition conditions is displayed as a related document. The degree of matching of metadata is calculated by combining numerical values indicating distances for data values of individual attributes (for example, a distance of a character string in the case of text, that of a value in the case of a numerical value, and the like).

In this embodiment, of annotated documents already pasted on the scrap document screen, an annotated document which does not meet the related document acquisition conditions (for example, Hotel ABC) is automatically deleted from the scrap document screen, as shown in FIG. 14. Annotated documents pasted on the scrap document screen may be left undeleted irrespective of whether or not they meet the related document acquisition conditions.

A document displayed as a related document is not limited to an annotated document, and may be a document on a Web which is not referred to by the user. In this case, assume that the related document acquisition unit 110 collects Web pages including product information of a specific domain in advance, and generates metadata.

In step S213 of FIG. 2, it is checked if the user presses the back button 606 (FIG. 6). If the user presses the back button 606, the scrap document generation processing ends, and the process returns to, for example, step S201 to display the annotate UI.

In this embodiment, the comparison table is generated by annotating the scrap document screen using the pen. Alternatively, a template document which describes in advance a comparison table used to compare products may be prepared in advance, and annotated documents may be pasted on that template, thus generating the comparison table.

As described above, the product comparison apparatus according to this embodiment can generate a comparison table which describes specification information items corresponding to products in response to a user operation for selecting these products to be compared using the pen. Furthermore, when the user inputs information on the comparison table using the pen, a product that meets a condition desired by the user can be additionally presented on the comparison table. Thus, product comparison can be made by a simple operation, that is, the operability upon product comparison can be improved.

Instructions in the processing sequences described in the aforementioned embodiment can be executed based on a program as software. A general-purpose computer system can store this program in advance and load the stored program, thus obtaining the same effects as those by the product comparison apparatus of the aforementioned embodiment. The instructions described in the aforementioned embodiment are recorded, as a program which can be executed by a computer, in a magnetic disk (flexible disk, hard disk, etc.), optical disk (CD-ROM, CD-R, CD-RW, DVD-ROM, DVD±R, DVD±RW, etc.), semiconductor memory, or similar recording medium. The storage format of a recording medium is not particularly limited as long as that recording medium is readable by a computer or embedded system. The computer can load the program from this recording medium, and control a CPU to execute instructions described in the program based on this program, thus implementing the same operation as the product comparison apparatus of the aforementioned embodiment. Of course, the computer may acquire or load the program via a network.

Also, an OS (Operating System), database management software, MW (middleware) for a network, or the like, which runs on a computer, may execute some of the processes required to implement this embodiment based on instructions of a program installed from the recording medium in a computer or embedded system.

Furthermore, the recording medium of this embodiment is not limited to a medium that is separate from a computer or embedded system, and includes a recording medium, which stores or temporarily stores a program downloaded via a LAN, the Internet, or the like.

The number of recording media is not limited to one, and the recording medium of this embodiment includes the case in which the processing of this embodiment is executed from a plurality of media. That is, the medium configuration is not particularly limited.

Note that the computer or embedded system of this embodiment is used to execute respective processes of this embodiment based on the program stored in the recording medium, and may have an arbitrary arrangement such as a single apparatus (for example, a personal computer, microcomputer, etc.), or a system in which a plurality of apparatuses are connected via a network.

The computer of this embodiment is not limited to a personal computer, and includes an arithmetic processing device, microcomputer, or the like included in an information processing apparatus, and is a generic name of a device and apparatus, which can implement the functions of this embodiment based on the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A product comparison apparatus for comparing a plurality of products, the apparatus comprising:
an operation acceptance unit configured to accept a user operation for selecting a plurality of annotated documents which include specification information items related to the products and annotations appended by a user;
a comparison table generator configured to generate a comparison table comprising the specification information items related to the products, in accordance with the user operation; and
a display unit configured to display the comparison table.

2. The apparatus according to claim 1, wherein the comparison table generator sets a search condition used to acquire a related document, based on the specification information items described in the comparison table.

3. The apparatus according to claim 2, further comprising:
a storage unit configured to store a plurality of annotated documents corresponding to a plurality of products; and
an acquisition unit configured to search the storage unit according to the search condition and acquire an annotated document which meets the search condition,
wherein the operation acceptance unit presents the annotated documents stored in the storage unit so that the user selects, using a pen, a plurality of annotated documents corresponding to a plurality of products to be compared from the presented annotated documents, and the comparison table generator adds a specification information item included in the acquired annotated document to the comparison table.

4. The apparatus according to claim 3, wherein when the user inputs character information to the comparison table using the pen, the comparison table generator changes the search condition according to the character information.

5. The apparatus according to claim 3, wherein when the user inputs a specific stroke to a specification information item described on the comparison table using the pen, the comparison table generator changes the search condition according to the specific stroke.

6. The apparatus according to claim 3, wherein when at least one of the selected annotated documents includes an annotation appended to a specification information item thereof, the comparison table generator sets the search condition based on the annotation appended to the specification information item.

7. The apparatus according to claim 3, wherein the comparison table generator deletes a specification information item related to an annotated document which does not meet the search condition from the comparison table.

8. The apparatus according to claim 2, further comprising:
a storage unit configured to store a plurality of annotated documents corresponding to a plurality of products; and
an acquisition unit configured to search the storage unit according to the search condition and acquire an annotated document which meets the search condition,
wherein the operation acceptance unit presents the annotated documents stored in the storage unit so that the user selects, by a drag operation, a plurality of annotated documents corresponding to a plurality of products to be compared from the presented annotated documents, and the comparison table generator adds a specification information item included in the acquired annotated document to the comparison table.

9. A product comparison method for comparing a plurality of products, comprising:
accepting a user operation for selecting a plurality of annotated documents which include specification information items related to the products and annotations appended by a user;
generating a comparison table comprising the specification information items related to the products, in accordance with the user operation; and
displaying the comparison table.

10. The method according to claim 9, wherein the generating comprises setting a search condition used to acquire a related document, based on the specification information items described in the comparison table.

11. The method according to claim 10, further comprising:
storing a plurality of annotated documents corresponding to a plurality of products in a storage unit; and
searching the storage unit according to the search condition and acquire an annotated document which meets the search condition,
wherein the accepting comprises presenting the annotated documents stored in the storage unit so that the user selects, using a pen, a plurality of annotated documents corresponding to a plurality of products to be compared from the presented annotated documents, and the generating further comprises adding a specification information item included in the acquired annotated document to the comparison table.

12. The method according to claim 11, wherein the generating further comprises changing the search condition according to character information when the user inputs the character information to the comparison table using the pen.

13. The method according to claim 11, wherein the generating further comprises changing the search condition according to a specific stroke when the user inputs the specific stroke to a specification information item described on the comparison table using the pen.

14. The method according to claim 11, wherein the generating further comprises setting the search condition based on an annotation appended to a specification information item when at least one of the selected annotated documents includes the annotation appended to the specification information item thereof.

15. The method according to claim 11, wherein the generating further comprises deleting a specification information item related to an annotated document which does not meet the search condition from the comparison table.

16. The method according to claim 10, further comprising:
storing a plurality of annotated documents corresponding to a plurality of products in a storage unit; and
searching the storage unit according to the search condition and acquire an annotated document which meets the search condition,
wherein the accepting comprises presenting the annotated documents stored in the storage unit so that the user selects, by a drag operation, a plurality of annotated documents corresponding to a plurality of products to be compared from the presented annotated documents, and the generating further comprises adding a specification information item included in the acquired annotated document to the comparison table.

17. A non-transitory computer readable medium including computer executable instructions, wherein the instructions, when executed by a processor, cause the processor to perform a method comprising:
accepting a user operation for selecting a plurality of annotated documents which include specification information items related to the products and annotations appended by a user;
generating a comparison table comprising the specification information items related to the of products, in accordance with the user operation; and
displaying the comparison table.
